(19) United States
(12) Patent Application Publication
(10) Pub. No.: US 2026/0134554 A1
(43) Pub. Date: May 14, 2026

(54) PEDESTRIAN COLLISION DETERMINATION SYSTEM, PEDESTRIAN COLLISION DETERMINATION APPARATUS, PEDESTRIAN COLLISION DETERMINATION METHOD, AND COMPUTER-READABLE MEDIUM

(71) Applicant: NEC Corporation, Minato-ku, Tokyo (JP)

(72) Inventor: Yasuhiro MIZUKOSHI, Tokyo (JP)

(73) Assignee: NEC Corporation, Minato-ku, Tokyo (JP)

(21) Appl. No.: 19/118,907

(22) PCT Filed: Oct. 28, 2022
(86) PCT No.: PCT/JP2022/040483

§ 371 Date: Apr. 7, 2025

(51) Int. Cl. G06T 7/246; G06T 7/269; G06T 7/62; G06T 7/73

(52) U.S. Cl. CPC G06T 7/251; G06T 7/269; G06T 7/62; G06T 7/75; G06T 2207/30196; G06T 2207/30236; G06T 2207/30261

(57) ABSTRACT

Provided is a pedestrian collision determination system including: an image capturing apparatus that is mounted on a vehicle and captures an image of surroundings of the vehicle; a first detection unit that detects a traveling direction of the vehicle; a second detection unit that detects a ground position of a pedestrian whose image has been captured by the image capturing apparatus; a third detection unit that detects an orientation of the pedestrian whose image has been captured by the image capturing apparatus; a possible collision area setting unit that sets a possible collision area having a shape and size according to an environment; and a determination unit that determines a possibility of collision between the vehicle and the captured pedestrian.

### TECHNICAL FIELD

The present disclosure relates to a pedestrian collision determination system, a pedestrian collision determination apparatus, a pedestrian collision determination method, and a computer-readable medium.

### BACKGROUND ART

Patent Literature 1 describes an invention that predicts a possibility of crossing of a pedestrian on a roadside of a traveling lane on which an own vehicle travels at an earlier stage and assists in preventing a collision with the pedestrian. In the invention described in Patent Literature 1, in a case where an oncoming pedestrian on a roadside of an opposite lane is crossing, a possibility of crossing is determined based on whether a pedestrian present ahead has recognized the crossing of the oncoming pedestrian on the basis of an orientation of a face of the pedestrian present ahead and whether the presence of the own vehicle has been recognized.

Patent Literature 2 describes an invention that appropriately assists driving of a driver in a case where there is a possibility of collision between an own vehicle and a pedestrian. The invention described in Patent Literature 2 captures an image of the pedestrian and recognizes an orientation of a face of the pedestrian. In addition, the invention described in Patent Literature 2 estimates whether there is a possibility of collision between the own vehicle and the pedestrian based on movements of the pedestrian. In addition, the invention described in Patent Literature 2 determines whether the presence of the own vehicle is recognized on the basis of the orientation of the face in a case where it is estimated there is a possibility of collision. In the invention described in Patent Literature 2, an alarm apparatus is controlled according to a determination result.

Patent Literature 3 describes an invention for improving the accuracy of determining a subject appearing in an image acquired by an image capturing apparatus. In the invention described in Patent Document 3, a processing unit performs, with respect to image data, processing that a skeleton model in which a plurality of feature points corresponding to four limbs are connected to a center feature point corresponding to a center of a human body is applied to the subject.

### CITATION LIST

### Patent Literature

Patent Literature 1: Japanese Unexamined Patent Application Publication No. 2012-234499
Patent Literature 2: Japanese Unexamined Patent Application Publication No. 2014-059841
Patent Literature 3: Japanese Unexamined Patent Application Publication No. 2021-060814

### SUMMARY OF INVENTION

### Technical Problem

However, Patent Literatures 1 to 3 do not refer in detail to a method of setting a possible collision area where a vehicle and a person are likely to collide. Therefore, an object of the present disclosure is to provide a pedestrian collision determination system that changes a shape and size of a possible collision area according to an environment.

### Solution to Problem

A pedestrian collision determination system according to the present disclosure is a pedestrian collision determination system including:
an image capturing apparatus mounted on a vehicle and configured to capture an image of surroundings of the vehicle;
a first detection means for detecting a traveling direction of the vehicle;
a second detection means for detecting a ground position of a pedestrian whose image has been captured by the image capturing apparatus;
a third detection means for detecting an orientation of the pedestrian whose image has been captured by the image capturing apparatus;
a possible collision area setting means for setting a possible collision area having a shape and a size according to an environment in which the image of the pedestrian has been captured by the image capturing apparatus; and
a determination means for determining a possibility of collision between the vehicle and the captured pedestrian based on the traveling direction of the vehicle detected by the first detection means, the ground position of the captured pedestrian detected by the second detection means, the orientation of the captured pedestrian detected by the third detection means, and the possible collision area set by the possible collision area setting means.

A pedestrian collision determination apparatus according to the present disclosure is a pedestrian collision determination apparatus including:
an image capturing apparatus mounted on a vehicle and configured to capture an image of surroundings of the vehicle;
a first detection means for detecting a traveling direction of the vehicle;
a second detection means for detecting a ground position of a pedestrian whose image has been captured by the image capturing apparatus;
a third detection means for detecting an orientation of the pedestrian whose image has been captured by the image capturing apparatus;
a possible collision area setting means for setting a possible collision area having a shape and a size according to an environment in which the image of the pedestrian has been captured by the image capturing apparatus; and
a determination means for determining a possibility of collision between the vehicle and the captured pedestrian based on the traveling direction of the vehicle detected by the first detection means, the ground position of the captured pedestrian detected by the second detection means, the orientation of the captured pedestrian detected by the third detection means, and the possible collision area set by the possible collision area setting means.

A pedestrian collision determination method according to the present disclosure is a pedestrian collision determination method including:
capturing an image of surroundings of a vehicle;
detecting a traveling direction of the vehicle;
detecting a ground position of the captured pedestrian;
detecting an orientation of the captured pedestrian;
setting a possible collision area having a shape and size according to an environment in which an image of the pedestrian has been captured; and
determining a possibility of collision between the vehicle and the captured pedestrian based on the detected traveling direction of the vehicle, the detected ground position of the captured pedestrian, the detected orientation of the captured pedestrian, and the set possible collision area.

A computer-readable medium of the present disclosure is a non-transitory computer-readable medium storing a program for causing an information processing apparatus to execute:
capturing an image of surroundings of a vehicle;
detecting a traveling direction of the vehicle;
detecting a ground position of the captured pedestrian;
detecting an orientation of the captured pedestrian;
setting a possible collision area having a shape and size according to an environment in which an image of the pedestrian has been captured; and
determining a possibility of collision between the vehicle and the captured pedestrian based on the detected traveling direction of the vehicle, the detected ground position of the captured pedestrian, the detected orientation of the captured pedestrian, and the set possible collision area.

### Advantageous Effects of Invention

According to the present disclosure, it is possible to provide the pedestrian collision determination system that changes the shape and size of the possible collision area according to the environment.

### BRIEF DESCRIPTION OF DRAWINGS

FIG. 1 is a schematic diagram of a pedestrian collision determination 5 system according to an example embodiment.

FIG. 2 is a block diagram illustrating a configuration of the pedestrian collision determination system according to the example embodiment.

FIG. 3 is a flowchart of a pedestrian collision determination method according to the example embodiment.

FIG. 4 is a view illustrating a method of detecting an orientation of a pedestrian according to the example embodiment.

FIG. 5 is a view illustrating examples of a ground position of a pedestrian and a possible pedestrian collision area according to the example embodiment.

### EXAMPLE EMBODIMENT

### Example Embodiment

Hereinafter, an example embodiment of the present invention will be described with reference to the drawings. However, the invention according to the claims is not limited to the following example embodiment. In addition, not all the configurations described in the example embodiment are essential as a means for solving the problem. To clarify description, omission and simplification are made as appropriate in the following description and drawings. In the drawings, the same elements are denoted by the same reference signs, and repeated description is omitted as necessary.

### (Description of Pedestrian Collision Determination System According to Example Embodiment)

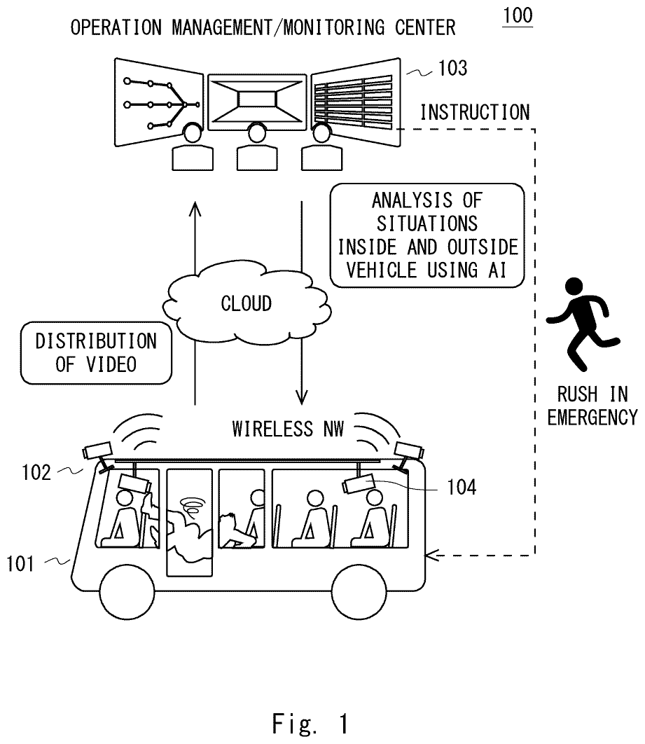

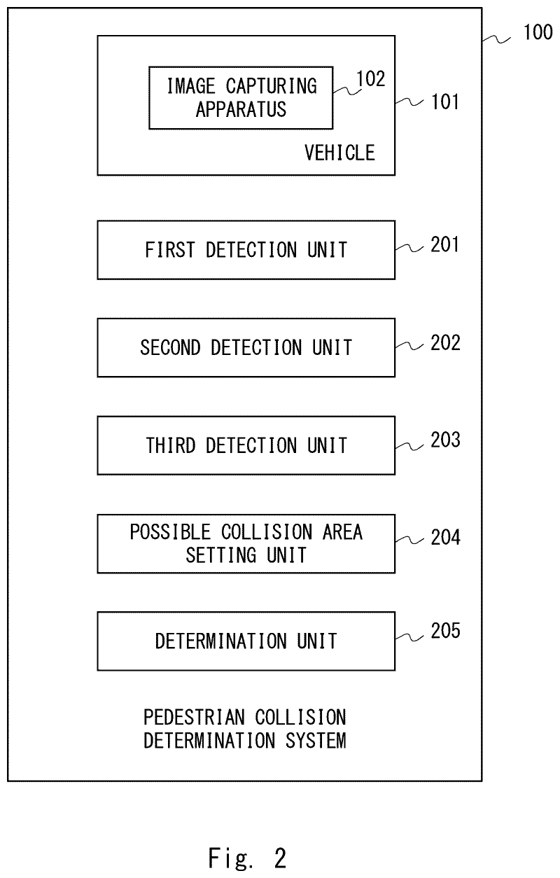

FIG. 1 is a schematic diagram of a pedestrian collision determination system according to an example embodiment. FIG. 2 is a block diagram illustrating a configuration of the pedestrian collision determination system according to the example embodiment. The pedestrian collision determination system according to the example embodiment will be described with reference to FIGS. 1 and 2.

As illustrated in FIG. 1, a pedestrian collision determination system 100 is a system used to assist automated driving or driving of a vehicle 101. The pedestrian collision determination system 100 is used to brake the vehicle or issue a warning to a driver or a remote monitor in a case where it is determined that the vehicle is highly likely to collide with a pedestrian. The pedestrian collision determination system 100 includes at least an image capturing apparatus 102 mounted on the vehicle 101 and an information processing apparatus 103.

The vehicle 101 is a mobile body carrying a person, such as a bus or a truck. The vehicle 101 may be driven by automated driving or may be driven by the driver. The vehicle 101 may be an unmanned mobile body on which no person rides.

The image capturing apparatus 102 is a vehicle exterior camera mounted on the vehicle to capture an image of an environment around the vehicle. The image capturing apparatus 102 captures an image of a pedestrian or a road around the vehicle. The image capturing apparatus 102 is connected to an operation management/monitoring center via a wireless network. The wireless network is, for example, a mobile communication network such as the fourth generation (4G), long term evolution (LTE), and the fifth generation (5G), Wi-Fi (registered trademark), or the like. The image capturing apparatus 102 distributes a captured video to the operation management/monitoring center.

In addition, the image capturing apparatus 102 may use one image capturing apparatus, two or three image capturing apparatuses, or four or more image capturing apparatuses according to an angle of view. In a case where an image capturing apparatus with a wide angle is used for the front, an image of a surrounding environment can be captured by one image capturing apparatus. I is possible to capture an image of the surrounding environment by combining captured images of two image capturing apparatuses facing two directions of the right front and the left front. In addition, an image of a surrounding environment can be captured by combining captured images of a plurality of image capturing apparatuses facing three directions of the right, center, and left. Similarly, an image of a surrounding environment can be captured by combining captured images of a plurality of image capturing apparatuses facing four or more directions.

A vehicle interior camera 104 may be installed in the vehicle 101. The vehicle interior camera 104 is an image capturing apparatus used to capture the inside of the vehicle to prevent a trouble inside the vehicle or cope with the trouble. The trouble inside the vehicle represents a passenger's stay, a passenger's fall, or the like. The vehicle interior camera 104 is also connected to the operation management/monitoring center via the wireless network. The vehicle interior camera 104 distributes a captured video to the operation management/monitoring center.

The operation management/monitoring center is a place provided outside the vehicle to manage and monitor the operation of the vehicle. The operation management/monitoring center collects information from a plurality of vehicles and simultaneously manages and monitors the plurality of vehicles. The operation management/monitoring center instructs personnel to rush in an emergency based on the video captured by the image capturing apparatus 102 or the vehicle interior camera 104. In addition, the operation management/monitoring center includes the information processing apparatus 103. The information processing apparatus 103 analyzes situations inside and outside the vehicle using artificial intelligence (AI).

The information processing apparatus 103 includes a memory that stores a program and a processor that executes the program. The information processing apparatus 103 may include one information processing apparatus or may include a plurality of information processing apparatuses. The information processing apparatus 103 may cause a cloud to execute some or all of the functions. Here, the information processing apparatus 103 is installed in the operation management/monitoring center, but may be partially or entirely installed in the vehicle 101. In a case where the information processing apparatus 103 is entirely installed in the vehicle 101, it can be said that the vehicle 101 is one pedestrian collision determination apparatus.

As illustrated in FIG. 2, the pedestrian collision determination system 100 includes the vehicle 101, the image capturing apparatus 102, a first detection unit 201, a second detection unit 202, a third detection unit 203, a possible collision area setting unit 204, and a determination unit 205. Here, the information processing apparatus 103 executes functions of the first detection unit 201, the second detection unit 202, the third detection unit 203, the possible collision area setting unit 204, and the determination unit 205.

The first detection unit 201 detects a traveling direction of the vehicle 101. The first detection unit 201 detects the traveling direction of the vehicle from a steering wheel operation and a turn signal operation of the driver.

The second detection unit 202 detects a ground position of a pedestrian whose image has been captured by the image capturing apparatus 102. The second detection unit 202 particularly focuses on feet of the pedestrian around the vehicle 101 and detects the ground position of the pedestrian on a road.

The third detection unit 203 detects an orientation of the pedestrian whose image has been captured by the image capturing apparatus 102. The third detection unit 203 detects in which direction the pedestrian around the vehicle 101 is facing.

The possible collision area setting unit 204 sets a possible collision area having a shape and size according to an environment in which the image of the pedestrian has been captured. The possible collision area having the size and shape according to the environment represents an area in which there is a possibility of collision with the vehicle, the area being changed in shape and size in front, rear, left, and right directions according to a surrounding road environment. The environment includes a speed of the vehicle, an acceleration of the vehicle, a road sign around the vehicle, and a road marking around the vehicle.

The determination unit 205 determines a possibility of collision between the vehicle 101 and the pedestrian based on the traveling direction of the vehicle 101, the ground position of the pedestrian, the orientation of the pedestrian, and the possible collision area set by the possible collision area setting unit. The determination unit 205 determines that there is a possibility of collision in a case where the traveling direction of the vehicle 101 from a position of the vehicle 101 intersects the orientation of the pedestrian from the ground position of the pedestrian. Furthermore, the determination unit 205 determines that the possibility of collision is high in a case where the ground position of the pedestrian is in the possible collision area.

The first detection unit 201 may also be rephrased as a first detection means. The second detection unit 202 may also be rephrased as a second detection means. The third detection unit 203 may also be rephrased as a third detection means. The possible collision area setting unit 204 may also be rephrased as a possible collision area setting means. The determination unit 205 may also be rephrased as a determination means.

As described above, it is possible to provide the pedestrian collision determination system that changes the shape and size of the possible collision area according to the environment.

### (Description of Pedestrian Collision Determination Method According to Example Embodiment)

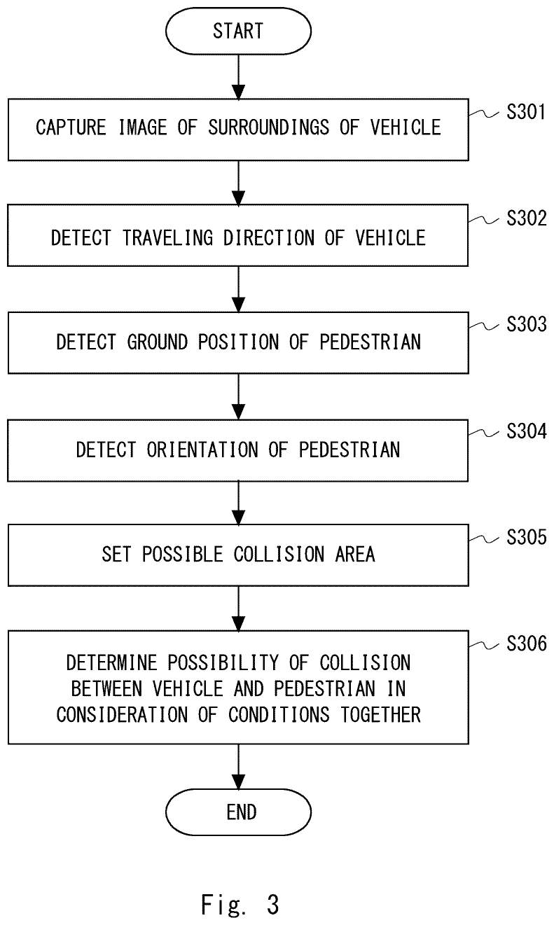

FIG. 3 is a flowchart of a pedestrian collision determination method according to the example embodiment. The pedestrian collision determination method according to the example embodiment will be described with reference to FIG. 3.

First, an image of surroundings of the vehicle 101 is captured (step S301). The image capturing apparatus 102 captures an image of an environment around the vehicle 101 and a pedestrian. The information processing apparatus 103 acquires the image of the pedestrian. Next, a traveling direction of the vehicle 101 is detected (step S302). The first detection unit 201 detects the traveling direction of the vehicle 101. Next, a ground position of the pedestrian is detected (step S303). The second detection unit 202 detects the ground position of the captured pedestrian. Next, an orientation of the pedestrian is detected (step S304). The third detection unit 203 detects the orientation of the captured pedestrian.

Next, a possible collision area is set (step S305). The possible collision area setting unit 204 sets the possible collision area having a shape and size according to the environment in which the image of the pedestrian has been captured. Next, a possibility of collision between the vehicle 101 and the pedestrian is determined in consideration of the respective conditions together (step S306), and the processing ends. The determination unit 205 determines the possibility of collision of the vehicle 101 with the pedestrian based on the traveling direction of the vehicle 101, the ground position of the pedestrian, the orientation of the pedestrian, and the possible collision area. In a case where the vehicle 101 is likely to collide with the pedestrian, it is possible to issue an instruction to assist driving of the vehicle 101, such as making the vehicle 101 prepare to apply a brake. In addition, the vehicle 101 may be braked.

As described above, it is possible to provide the pedestrian determination method that changes the shape and size of the possible collision area according to the environment.

### (Description of Method of Detecting Orientation of Pedestrian According to Example Embodiment)

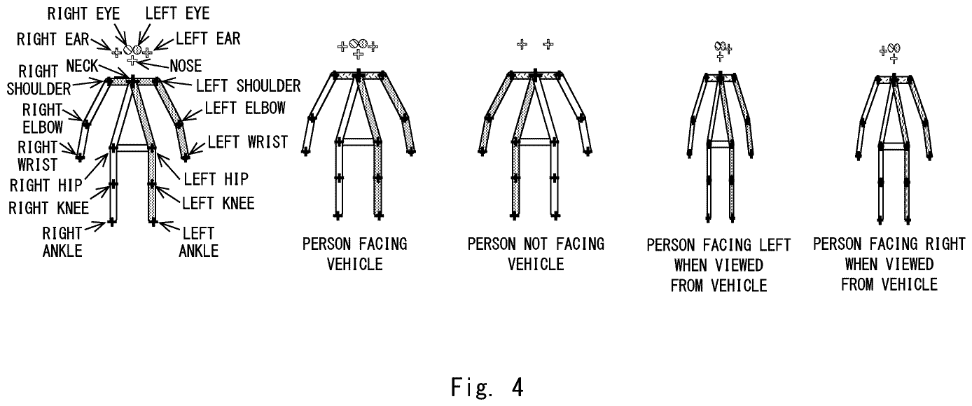

FIG. 4 is a view illustrating a method of detecting an orientation of a pedestrian according to the example embodiment. The method of detecting an orientation of a pedestrian according to the example embodiment will be described with reference to FIG. 4.

As illustrated in a left view of FIG. 4, feature points of a skeleton of a pedestrian are extracted from an image of the pedestrian. An orientation of the pedestrian is detected based on a state of the skeleton of the pedestrian. For example, feature points, such as a right eye, a left eye, a right ear, a left ear, a nose, a neck, a right shoulder, a left shoulder, a right elbow, a left elbow, a right wrist, a left wrist, a right hip, a left hip, a right knee, a left knee, a right ankle, and a left ankle, are extracted. Then, as illustrated in the second view from the left of FIG. 4, feature points of eyes and a nose are recognized from a person facing the front of the vehicle. In addition, regarding the person facing the front of the vehicle, feature points of the skeleton on the right side appear on the left side, and feature points of the skeleton on the left side appear on the right side. As illustrated in the middle view of FIG. 4, feature points of eyes and a nose are not recognized from a person not facing the vehicle. In addition, regarding the person not facing the vehicle, feature points of the skeleton on the right side appear on the right side, and feature points of the skeleton on the left side appear on the left side.

As illustrated in the second view from the right of FIG. 4, eyes and a nose on the left side of a neck are recognized from a person facing the left when viewed from the vehicle. In addition, regarding the person facing the left when viewed from the vehicle, feature points of the skeleton on the right side appear on the left side, and feature points of the skeleton on the left side appear on the right side. As illustrated in the right view of FIG. 4, eyes and a nose on the right side of a neck are recognized from a person facing the right when viewed from the vehicle. In addition, regarding the person facing the right when viewed from the vehicle, feature points of the skeleton on the right side appear on the right side, and feature points of the skeleton on the left side appear on the left side.

As described above, the orientation of the pedestrian can be detected using AI that uses the feature points of the skeleton of the pedestrian as inputs to output any direction in which the pedestrian is facing.

### (Description of Setting of Possible Collision Area According to Example Embodiment)

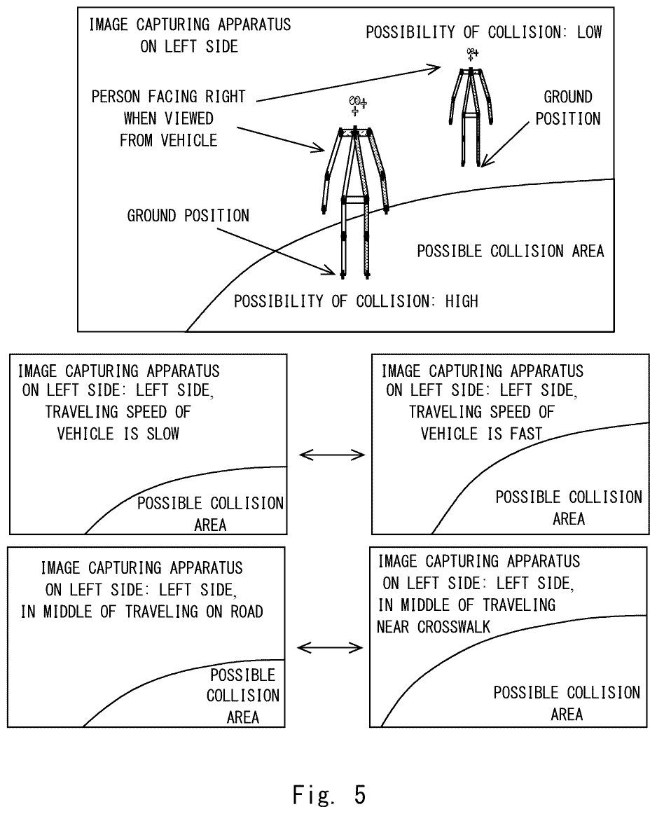

FIG. 5 is a view illustrating examples of a ground position of a pedestrian and a possible pedestrian collision area according to the example embodiment. The setting of a possible collision area will be described with reference to FIG. 5.

The upper view of FIG. 5 illustrates a surrounding environment whose image has been captured by an image capturing apparatus on the left side among three image capturing apparatuses attached to a vehicle on the right, left, and center, for example. As illustrated in the upper view of FIG. 5, a traveling direction of the vehicle intersects a traveling direction of a person facing the right when viewed from the vehicle, so that there is a possibility of collision between the vehicle and the pedestrian. A person who faces the right and whose ground position is in the possible collision area is determined to have a high possibility of collision. At this time, control of the vehicle may be affected. On the other hand, a person who faces the right and whose ground position is not in the possible collision area is determined to have a low possibility of collision.

The shape and size of the possible collision area change according to the surrounding environment. Specific examples thereof are illustrated in the central views and the lower views of FIG. 5. The central views of FIG. 5 are captured from an image capturing apparatus installed on the left of the vehicle similarly to the upper view. As illustrated in the left view out of the central views of FIG. 5, in a case where the vehicle travels on a left lane and a traveling speed of the vehicle is slow, the possible collision area spreads from the center where the vehicle is present and extends in the front and left directions, but the area is not so large. On the other hand, as illustrated in the right view out of the central views of FIG. 5, in a case where the vehicle travels on the left lane and the traveling speed of the vehicle is fast, the possible collision area spreads from the center and greatly extends forward. This is because the possible collision area extends forward in a case where the vehicle is fast. The possible collision area is preferably set to have a shape and size increased forward as the vehicle is faster and decreased forward as the vehicle is slower.

In addition, as illustrated in the right view out of the lower views of FIG. 5, in a case where the vehicle is traveling on the left lane road in the left-hand traffic, the possible collision area spreads from the center and extends forward and leftward, but the area is not so large. On the other hand, as illustrated in the right view out of the lower views of FIG. 5, in a case where the vehicle is traveling on the left lane and traveling in front of a crosswalk, the possible collision area spreads from the center and greatly extends forward and leftward. This is because there is a high possibility that a pedestrian enters from the left near the crosswalk. Here, the leftward direction is taken as an example, but the rightward direction may be used in the right-hand traffic, and more accurately, a roadside direction is applied. The same may apply in front of an intersection, a railroad crossing, or a traffic light.

Although not illustrated, in a case where there is a stop near the vehicle, the possible collision area preferably has a shape and size including an area extending from the vehicle to the stop. This is because there is a high possibility that a person is waiting near the stop.

In addition, although not illustrated, in a case where the vehicle turns right, the possible collision area preferably has a shape and size large on the right side. This is because there is a high possibility that a person enters from the right side. Similarly, in a case where the vehicle turns left, the possible collision area preferably has a shape and size large on the left side. This is because there is a high possibility that a person enters from the left side.

In addition, although not illustrated, the possible collision area preferably has a shape and size according to a gradient of a road on which the vehicle travels. In a case where the vehicle is on an uphill, the possible collision area preferably has a shape and size small on the front according to a range in which the front can be visually recognized. In a case where the vehicle is on the uphill, the vehicle is likely to stop, and the possible collision area can be made small on the front. In addition, it can be said that the gradient of the uphill is proportional to the range in which the front can be visually recognized. Similarly, in a case where the vehicle is on a downhill, the possible collision area preferably has a shape and size large on the front side according to a range in which the front can be visually recognized. In a case where the vehicle is on the downhill, the vehicle is hard to stop, and the possible collision area needs to be increased forward. In addition, it can be said that the gradient of the downhill is proportional to the range in which the front can be visually recognized.

As described above, the possible pedestrian collision area can be set to have the shape and size according to the environment around the vehicle.

In addition, a part or all of the processing in the information processing apparatus 103 described above can be realized as a computer program. Such a program can be stored and supplied to the computer using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (e.g., a magneto-optical disc), a CD-read only memory (ROM), a CD-R, a CD-R/W, and a semiconductor memory (e.g., a mask ROM, a programmable ROM (PROM), an erasable PROM (EPROM), a flash ROM, or a random access memory (RAM)). In addition, the program may be supplied to the computer using various types of transitory computer-readable media. Examples of the transitory computer-readable media include electrical signals, optical signals, and electromagnetic waves. The transitory computer-readable medium can provide the program to the computer via a wired communication line such as an electric wire and optical fibers or a wireless communication line.

The present invention is not limited to the above example embodiment, and can be appropriately changed without departing from the gist.

Some or all of the above example embodiment may be described as the following supplementary notes but are not limited to the following.

### (Supplementary Note 1)

A pedestrian collision determination system including:
an image capturing apparatus mounted on a vehicle and configured to capture an image of surroundings of the vehicle;
a first detection means for detecting a traveling direction of the vehicle;
a second detection means for detecting a ground position of a pedestrian whose image has been captured by the image capturing apparatus;
a third detection means for detecting an orientation of the pedestrian whose image has been captured by the image capturing apparatus;
a possible collision area setting means for setting a possible collision area having a shape and a size according to an environment in which the image of the pedestrian has been captured by the image capturing apparatus; and
a determination means for determining a possibility of collision between the vehicle and the captured pedestrian based on the traveling direction of the vehicle detected by the first detection means, the ground position of the captured pedestrian detected by the second detection means, the orientation of the captured pedestrian detected by the third detection means, and the possible collision area set by the possible collision area setting means.

### (Supplementary Note 2)

The pedestrian collision determination system according to Supplementary Note 1, wherein the determination means determines that the possibility of collision is high in a case where the traveling direction of the vehicle from a position of the vehicle intersects the orientation of the pedestrian from the ground position of the pedestrian and the ground position of the pedestrian is in the possible collision area.

### (Supplementary Note 3)

The pedestrian collision determination system according to Supplementary Note 1 or 2, wherein the possible collision area setting means sets the possible collision area to have a shape and size increased forward when viewed from the vehicle as a speed of the vehicle is faster and decreased forward when viewed from the vehicle as the speed of the vehicle is slower.

### (Supplementary Note 4)

The pedestrian collision determination system according to Supplementary Note 1 or 2, wherein the possible collision area setting means sets the possible collision area to have a shape and size large in a roadside direction and forward when viewed from the vehicle in a case where the vehicle is in front of a crosswalk, an intersection, a railroad crossing, or a traffic light.

### (Supplementary Note 5)

The pedestrian collision determination system according to Supplementary Note 1 or 2, wherein, in a case where there is a stop near the vehicle, the possible collision area setting means sets the possible collision area to have a shape and size including an area extending from the vehicle to the stop.

### (Supplementary Note 6)

The pedestrian collision determination system according to Supplementary Note 1 or 2, wherein the possible collision area setting means sets the possible collision area to have a shape and size large on a right side in a case where the vehicle turns right and large on a left side in a case where the vehicle turns left.

### (Supplementary Note 7)

The pedestrian collision determination system according to Supplementary Note 1 or 2, wherein the possible collision area setting means sets the possible collision area to have a shape and size according to a gradient of a road on which the vehicle travels.

### (Supplementary Note 8)

The pedestrian collision determination system according to Supplementary Note 1, wherein the third detection means detects the orientation of the pedestrian based on a state of a skeleton of the pedestrian.

### (Supplementary Note 9)

A pedestrian collision determination apparatus including:
an image capturing apparatus mounted on a vehicle and configured to capture an image of surroundings of the vehicle;
a first detection means for detecting a traveling direction of the vehicle;
a second detection means for detecting a ground position of a pedestrian whose image has been captured by the image capturing apparatus;
a third detection means for detecting an orientation of the pedestrian whose image has been captured by the image capturing apparatus;
a possible collision area setting means for setting a possible collision area having a shape and a size according to an environment in which the image of the pedestrian has been captured by the image capturing apparatus; and
a determination means for determining a possibility of collision between the vehicle and the captured pedestrian based on the traveling direction of the vehicle detected by the first detection means, the ground position of the captured pedestrian detected by the second detection means, the orientation of the captured pedestrian detected by the third detection means, and the possible collision area set by the possible collision area setting means.

### (Supplementary Note 10)

The pedestrian collision determination apparatus according to Supplementary Note 9, wherein the determination means determines that the possibility of collision is high in a case where the traveling direction of the vehicle from a position of the vehicle intersects the orientation of the pedestrian from the ground position of the pedestrian and the ground position of the pedestrian is in the possible collision area.

### (Supplementary Note 11)

The pedestrian collision determination apparatus according to Supplementary Note 9 or 10, wherein the possible collision area setting means sets the possible collision area to have a shape and size increased forward when viewed from the vehicle as a speed of the vehicle is faster and decreased forward when viewed from the vehicle as the speed of the vehicle is slower.

### (Supplementary Note 12)

The pedestrian collision determination apparatus according to Supplementary Note 9 or 10, wherein the possible collision area setting means sets the possible collision area to have a shape and size large in a roadside direction and forward when viewed from the vehicle in a case where the vehicle is in front of a crosswalk, an intersection, a railroad crossing, or a traffic light.

### (Supplementary Note 13)

The pedestrian collision determination apparatus according to Supplementary Note 9 or 10, wherein, in a case where there is a stop near the vehicle, the possible collision area setting means sets the possible collision area to have a shape and size including an area extending from the vehicle to the stop.

### (Supplementary Note 14)

The pedestrian collision determination apparatus according to Supplementary Note 9 or 10, wherein the possible collision area setting means sets the possible collision area to have a shape and size large on a right side in a case where the vehicle turns right and large on a left side in a case where the vehicle turns left.

### (Supplementary Note 15)

The pedestrian collision determination apparatus according to Supplementary Note 9 or 10, wherein the possible collision area setting means sets the possible collision area to have a shape and size according to a gradient of a road on which the vehicle travels.

### (Supplementary Note 16)

The pedestrian collision determination apparatus according to Supplementary Note 9, wherein the third detection means detects the orientation of the pedestrian based on a state of a skeleton of the pedestrian.

### (Supplementary Note 17)

A pedestrian collision determination method including:
capturing an image of surroundings of a vehicle;
detecting a traveling direction of the vehicle;
detecting a ground position of the captured pedestrian;
detecting an orientation of the captured pedestrian;
setting a possible collision area having a shape and size according to an environment in which an image of the pedestrian has been captured; and
determining a possibility of collision between the vehicle and the captured pedestrian based on the detected traveling direction of the vehicle, the detected ground position of the captured pedestrian, the detected orientation of the captured pedestrian, and the set possible collision area.

### (Supplementary Note 18)

The pedestrian collision determination method according to Supplementary Note 17, wherein the possibility of collision is determined to be high in a case where the traveling direction of the vehicle from a position of the vehicle intersects the orientation of the pedestrian from the ground position of the pedestrian and the ground position of the pedestrian is in the possible collision area.

### (Supplementary Note 19)

The pedestrian collision determination method according to Supplementary Note 17 or 18, wherein the possible collision area is set to have a shape and size increased forward when viewed from the vehicle as a speed of the vehicle is faster and decreased forward when viewed from the vehicle as the speed of the vehicle is slower.

### (Supplementary Note 20)

The pedestrian collision determination method according to Supplementary Note 17 or 18, wherein the possible collision area is set to have a shape and size large in a roadside direction and forward when viewed from the vehicle in a case where the vehicle is in front of a crosswalk, an intersection, a railroad crossing, or a traffic light.

### (Supplementary Note 21)

The pedestrian collision determination method according to Supplementary Note 17 or 18, wherein, in a case where there is a stop near the vehicle, the possible collision area is set to have a shape and size including an area extending from the vehicle to the stop.

### (Supplementary Note 22)

The pedestrian collision determination method according to Supplementary Note 17 or 18, wherein the possible collision area is set to have a shape and size large on a right side in a case where the vehicle turns right and large on a left side in a case where the vehicle turns left.

### (Supplementary Note 23)

The pedestrian collision determination method according to Supplementary Note 17 or 18, wherein the possible collision area is set to have a shape and size according to a gradient of a road on which the vehicle travels.

### (Supplementary Note 24)

The pedestrian collision determination method according to Supplementary Note 17, wherein the orientation of the pedestrian is detected based on a state of a skeleton of the pedestrian.

### (Supplementary Note 25)

A non-transitory computer-readable medium storing a program for causing an information processing apparatus to execute:
capturing an image of surroundings of a vehicle;
detecting a traveling direction of the vehicle;
detecting a ground position of the captured pedestrian;
detecting an orientation of the captured pedestrian;
setting a possible collision area having a shape and size according to an environment in which an image of the pedestrian has been captured; and
determining a possibility of collision between the vehicle and the captured pedestrian based on the detected traveling direction of the vehicle, the detected ground position of the captured pedestrian, the detected orientation of the captured pedestrian, and the set possible collision area.

### (Supplementary Note 26)

The non-transitory computer-readable medium storing a program according to Supplementary Note 25, wherein the possibility of collision is determined to be high in a case where the traveling direction of the vehicle from a position of the vehicle intersects the orientation of the pedestrian from the ground position of the pedestrian and the ground position of the pedestrian is in the possible collision area.

### (Supplementary Note 27)

The non-transitory computer-readable medium storing a program according to Supplementary Note 25 or 26, wherein the possible collision area is set to have a shape and size increased forward according to a speed of the vehicle as the speed is faster and decreased forward according to the speed of the vehicle as the speed is slower.

### (Supplementary Note 28)

The non-transitory computer-readable medium storing a program according to Supplementary Note 25 or 26, wherein the possible collision area is set to have a shape and size large in a roadside direction and forward when viewed from the vehicle in a case where the vehicle is in front of a crosswalk, an intersection, a railroad crossing, or a traffic light.

### (Supplementary Note 29)

The non-transitory computer-readable medium storing a program according to Supplementary Note 25 or 26, wherein, in a case where there is a stop near the vehicle, the possible collision area is set to have a shape and size including an area extending from the vehicle to the stop.

### (Supplementary Note 30)

The non-transitory computer-readable medium storing a program according to Supplementary Note 25 or 26, wherein the possible collision area is set to have a shape and size large on a right side in a case where the vehicle turns right and large on a left side in a case where the vehicle turns left.

### (Supplementary Note 31)

The non-transitory computer-readable medium storing a program according to Supplementary Note 25 or 26, wherein the possible collision area is set to have a shape and size according to a gradient of a road on which the vehicle travels.

### (Supplementary Note 32)

The non-transitory computer-readable medium storing a program according to Supplementary Note 25, wherein the orientation of the pedestrian is detected based on a state of a skeleton of the pedestrian.

Reference Signs List

| | |
|---|---|
| 100 | PEDESTRIAN COLLISION DETERMINATION SYSTEM |
| 101 | VEHICLE |
| 102 | IMAGE CAPTURING APPARATUS |
| 103 | INFORMATION PROCESSING APPARATUS |
| 201 | FIRST DETECTION UNIT |
| 202 | SECOND DETECTION UNIT |
| 203 | THIRD DETECTION UNIT |
| 204 | POSSIBLE COLLISION AREA SETTING UNIT |
| 205 | DETERMINATION UNIT |

What is claimed is:

1. A pedestrian collision determination system comprising:
an image capturing apparatus mounted on a vehicle and configured to capture an image of surroundings of the vehicle;
a first detection unit for detecting a traveling direction of the vehicle;
a second detection unit for detecting a ground position of a pedestrian whose image has been captured by the image capturing apparatus;
a third detection unit for detecting an orientation of the pedestrian whose image has been captured by the image capturing apparatus;
a possible collision area setting unit for setting a possible collision area having a shape and size according to an environment in which the image of the pedestrian has been captured by the image capturing apparatus; and
a determination unit for determining a possibility of collision between the vehicle and the captured pedestrian based on the traveling direction of the vehicle detected by the first detection unit, the ground position of the captured pedestrian detected by the second detection unit, the orientation of the captured pedestrian detected by the third detection unit, and the possible collision area set by the possible collision area setting unit.

2. The pedestrian collision determination system according to claim 1, wherein the determination unit determines that the possibility of collision is high in a case where the traveling direction of the vehicle from a position of the vehicle intersects the orientation of the pedestrian from the ground position of the pedestrian and the ground position of the pedestrian is in the possible collision area.

3. The pedestrian collision determination system according to claim 1, wherein the possible collision area setting unit sets the possible collision area to have a shape and size increased forward when viewed from the vehicle as a speed of the vehicle is faster and decreased forward when viewed from the vehicle as the speed of the vehicle is slower.

4. The pedestrian collision determination system according to claim 1, wherein the possible collision area setting unit sets the possible collision area to have a shape and size large in a roadside direction and forward when viewed from the vehicle in a case where the vehicle is in front of a crosswalk, an intersection, a railroad crossing, or a traffic light.

5. The pedestrian collision determination system according to claim 1, wherein, in a case where there is a stop near the vehicle, the possible collision area setting unit sets the possible collision area to have a shape and size including an area extending from the vehicle to the stop.

6. The pedestrian collision determination system according to claim 1, wherein the possible collision area setting unit sets the possible collision area to have a shape and size large on a right side in a case where the vehicle turns right and large on a left side in a case where the vehicle turns left.

7. The pedestrian collision determination system according to claim 1, wherein the possible collision area setting unit sets the possible collision area to have a shape and size according to a gradient of a road on which the vehicle travels.

8. The pedestrian collision determination system according to claim 1, wherein the third detection unit detects the orientation of the pedestrian based on a state of a skeleton of the pedestrian.

9. A pedestrian collision determination apparatus comprising:
an image capturing apparatus mounted on a vehicle and configured to capture an image of surroundings of the vehicle;
a first detection unit for detecting a traveling direction of the vehicle;
a second detection unit for detecting a ground position of a pedestrian whose image has been captured by the image capturing apparatus;
a third detection unit for detecting an orientation of the pedestrian whose image has been captured by the image capturing apparatus;
a possible collision area setting unit for setting a possible collision area having a shape and a size according to an environment in which the image of the pedestrian has been captured by the image capturing apparatus; and
a determination unit for determining a possibility of collision between the vehicle and the captured pedestrian based on the traveling direction of the vehicle detected by the first detection unit, the ground position of the captured pedestrian detected by the second detection unit, the orientation of the captured pedestrian detected by the third detection unit, and the possible collision area set by the possible collision area setting unit.

10. The pedestrian collision determination apparatus according to claim 9, wherein the determination unit determines that the possibility of collision is high in a case where the traveling direction of the vehicle from a position of the vehicle intersects the orientation of the pedestrian from the ground position of the pedestrian and the ground position of the pedestrian is in the possible collision area.

11. The pedestrian collision determination apparatus according to claim 9, wherein the possible collision area setting unit sets the possible collision area to have a shape and size increased forward when viewed from the vehicle as a speed of the vehicle is faster and decreased forward when viewed from the vehicle as the speed of the vehicle is slower.

12. The pedestrian collision determination apparatus according to claim 9, wherein the possible collision area setting unit sets the possible collision area to have a shape and size large in a roadside direction and forward when viewed from the vehicle in a case where the vehicle is in front of a crosswalk, an intersection, a railroad crossing, or a traffic light.

13. The pedestrian collision determination apparatus according to claim 9, wherein, in a case where there is a stop near the vehicle, the possible collision area setting unit sets the possible collision area to have a shape and size including an area extending from the vehicle to the stop.

14. The pedestrian collision determination apparatus according to claim 9, wherein the possible collision area setting unit sets the possible collision area to have a shape and size large on a right side in a case where the vehicle turns right and large on a left side in a case where the vehicle turns left.

15. The pedestrian collision determination apparatus according to claim 9, wherein the possible collision area setting unit sets the possible collision area to have a shape and size according to a gradient of a road on which the vehicle travels.

16. The pedestrian collision determination apparatus according to claim 9, wherein the third detection unit detects the orientation of the pedestrian based on a state of a skeleton of the pedestrian.

17. A pedestrian collision determination method comprising:
capturing an image of surroundings of a vehicle;
detecting a traveling direction of the vehicle;
detecting a ground position of the captured pedestrian;
detecting an orientation of the captured pedestrian;
setting a possible collision area having a shape and size according to an environment in which an image of the pedestrian has been captured; and
determining a possibility of collision between the vehicle and the captured pedestrian based on the detected traveling direction of the vehicle, the detected ground position of the captured pedestrian, the detected orientation of the captured pedestrian, and the set possible collision area.

18. The pedestrian collision determination method according to claim 17, wherein the possibility of collision is determined to be high in a case where the traveling direction of the vehicle from a position of the vehicle intersects the orientation of the pedestrian from the ground position of the pedestrian and the ground position of the pedestrian is in the possible collision area.

19. The pedestrian collision determination method according to claim 17, wherein the possible collision area is set to have a shape and size increased forward when viewed from the vehicle as a speed of the vehicle is faster and decreased forward when viewed from the vehicle as the speed of the vehicle is slower.

20. A non-transitory computer-readable medium storing a program for causing an information processing apparatus to execute the pedestrian collision determination method according to claim 17.
